(19) United States
(12) Patent Application Publication
(10) Pub. No.: US 2006/0286971 A1
(43) Pub. Date: Dec. 21, 2006

(54) Automatic storage of contact information on a cellular phone

(76) Inventors: John W. Maly, LaPorte, CO (US); Lisa F. Maly, LaPorte, CO (US)

Correspondence Address: John W. Maly, Esq., 13500 Owl Canyon Trail, LaPorte, CO, 80535, US

(21) Appl. No.: 11/155,247

(22) Filed: Jun. 17, 2005

(51) Int. Cl. H04M 3/42

(52) U.S. Cl. 455/415

(57) ABSTRACT

Client-side and server-side methods and systems for the automatic storage of contact information on a cellular phone are disclosed. Contact information is received from a directory assistance service, and stored in the memory of a cellular phone. The contact information may be placed in memory associated with a contact list (phonebook), memory associated with recently dialed calls, or both. A redial function may also leverage the contact information. When new information is received relating to an existing contact, the existing contact information may be replaced by, or updated with, the new contact information. Alternatively, an additional entry can be added for the contact information, and the existing contact retained.

### BACKGROUND OF THE INVENTION

As referenced in this disclosure, a cellular phone is a wireless communication device capable of establishing a connection to a phone (said connection being a phone call) wherein auditory data may be transmitted and received. A cellular phone may also have additional functionality, such as mobile computing capability, internet connectivity, and media playing capability. Most cellular phones contain a body of contact information known as a phonebook, an addressbook, or a contacts list. This phonebook allows a cellular phone user to store important or frequently used phone numbers in the memory of a cellular phone for easy access.

A phone number can later be retrieved by finding the name of a contact in the list, and accessing the associated phone number(s) for that contact. In some cellular phones, additional data may also be stored in a phonebook, such as one or more business names associated with a contact, one or more mailing addresses of a contact, one or more email addresses of a contact, one or more names of a contact's family members, a specification of which text to show when the contact calls the user, and a specification of which ring sound to play should the contact call the user.

Cellular phone technology has been rapidly advancing in recent years. Many cellular phones now allow a user to transmit and receive textual messages, graphical images, photographic images, recorded sounds, and even streaming media. Some cellular phones are also capable of receiving email messages forwarded from an email service, such that a user may check his or her email via the cellular phone.

One problem cellular phone users face is finding new phone numbers, and entering them into the cellular phone's phonebook. To accomplish this, a cellular phone user must typically call a directory assistance service for a phone number, write the phone number down or memorize the phone number, and then painstakingly enter the phone number and an associated contact name into the phonebook. To compound the problem, text must often be entered into a cellular phone using a cumbersome data entry system that may require multiple button presses for a single letter. Further, if the address of the contact is desired, a special request must often be made to the directory assistance service, and the address similarly written down and later entered into the phonebook. Such procedures can prove difficult, if not impossible, to a cellular phone user who is presently engaged in another activity, such as driving an automobile. Services exist to send contact data from a contact list on a computer to a cellular phone, but this is not an option when a cellular phone user with this service is not near his or her computer.

Some cellular phone directory assistance services offer to automatically dial the requested phone number. However, using such an automatic dial service does not place the phone number in the memory of the user's cellular phone. Further, subsequently pressing the “redial” button on the cellular phone simply redials directory assistance, and not the phone number of the requested contact to whom the call was ultimately placed.

It is with respect to these considerations and others that the present invention has been made.

### SUMMARY OF THE INVENTION

In accordance with the present invention, a method is provided for automatic storage of contact information received from a directory assistance service into a cellular phone memory. First, contact information from a directory assistance service is received on a cellular phone. Next, the contact information is automatically stored in a memory of the cellular phone.

In accordance with other aspects, a method for retrieval and transmission of requested contact information to a cellular phone for automatic storage in a memory of the cellular phone is disclosed. First, a request for contact information is received. Next, the requested contact information is retrieved from a database. Finally, the requested contact information is transmitted to a cellular phone for automatic storage in the memory of the cellular phone.

In accordance with yet other aspects, the present invention relates to a system for automatic storage of contact information received from a directory assistance service into a cellular phone memory. An I/O module receives input from a user, and displays information to the user. A receiver/transmitter module transmits requests for contact information to a directory assistance service, and receives contact information from the directory assistance service. A download module manages downloads of contact information received through the receiver/transmitter module. A phonebook module stores and retrieves contact information downloaded by the download module. A dialing module dials phone numbers. Finally, a memory is provided for storage of contact information associated with the phonebook module.

These and various other features as well as advantages, which characterize the present invention, will be apparent from a reading of the following detailed description and a review of the associated drawings.

### BRIEF DESCRIPTION OF THE DRAWINGS

FIG. 1 illustrates a prompt for automatic contact information storage in accordance with an embodiment of the claimed invention.

FIG. 2 illustrates the operational flow of the operations performed in accordance with one embodiment of the present invention.

FIG. 3 illustrates the operational flow of the operations performed in accordance with one embodiment of the present invention.

FIG. 4 illustrates the operational flow of the operations performed in accordance with one embodiment of the present invention.

FIG. 5 illustrates the operational flow of the operations performed in accordance with one embodiment of the present invention.

FIG. 6 is a block diagram illustrating the modules that comprise one embodiment of the present invention.

### DETAILED DESCRIPTION OF THE INVENTION

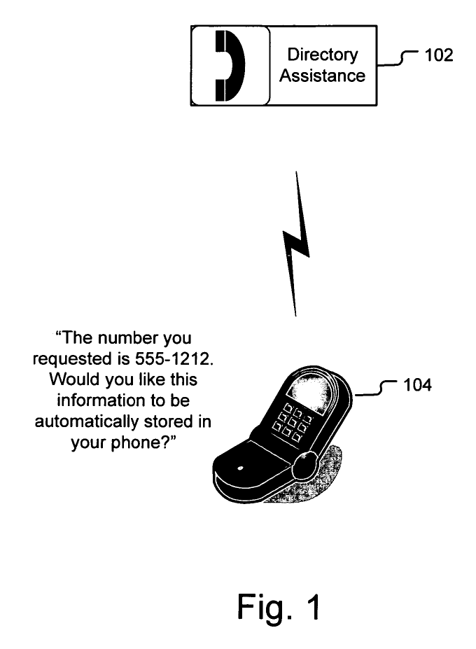

FIG. 1 illustrates a prompt operation in accordance with an embodiment of the claimed invention wherein the cellular phone user is asked whether they wish a requested phone number to be automatically stored in the memory of cellular phone 104. The cellular phone 104 is in wireless communication with a directory assistance service 102. Directory assistance service 102 is transmitting the requested phone number verbally or visually, and offering to store the phone number in the cellular phone 104.

If the cellular phone user responds affirmatively, the phone number will be received by the cellular phone 104 from directory assistance service 102 or a related data server (not pictured), and stored in the memory of cellular phone 104. In an embodiment, the phone number will be stored in an area of cellular phone memory associated with a phonebook. In another embodiment, the phone number will be stored in an area of cellular phone memory associated with one or more recently dialed calls. In yet another embodiment, the phone number will be stored in both areas of memory, or in an area of memory associated with both functions.

Additional contact information may also be stored in the memory of cellular phone 104. More specifically, contact information that may be stored in the memory of cellular phone 104 may include, but is not limited to, the name of the contact, a photographic image associated with the contact, one or more phone numbers, one or more associated business names, a digital image containing a business logo or advertisement, one or more mailing addresses, a date of birth for the contact, one or more email addresses, one or more web addresses or other Uniform Resource Identifiers (URIs), one or more names of family members of the contact, and/or an audio recording of a name, message, business-related soundbyte or advertisement.

In an alternate embodiment, some or all contact information associated with a contact will be stored in an area of cellular phone memory associated with a phonebook when the user responds affirmatively to a prompt to automatically store the phone number, or alternatively, in an area of cellular phone memory associated with recently dialed calls when the user responds negatively to said prompt. In another embodiment, information stored in an area of cellular phone memory associated with recently dialed calls may be copied to, or moved to, an area of cellular phone memory associated with a phonebook.

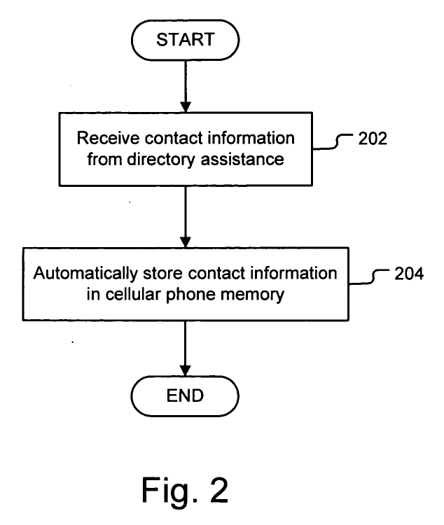

In still other embodiments, discussed below in conjunction with FIG. 2, no such prompt need be presented to the cellular phone user before contact information is stored in the memory cell cellular phone 104. In one embodiment, directory assistance service 102 additionally offers to dial a requested phone number. In another embodiment, directory assistance service 102 allows a plurality requests for contact information during a single phone call or connection to directory assistance service 102.

FIG. 2 illustrates the operations performed in accordance with an embodiment of the claimed invention in which contact information is automatically stored to the memory of a cellular phone. Receive operation 202 receives contact information from a directory assistance service. Contact information may include, but is not limited to, a contact name, a photographic image associated with the contact, one or more phone numbers, one or more associated business names, a digital image containing a business logo or advertisement, one or more mailing addresses, one or more email addresses, one or more web addresses or other URIs, one or more names of family members of the contact, and/or an audio recording of a name, message, business-related soundbyte or advertisement.

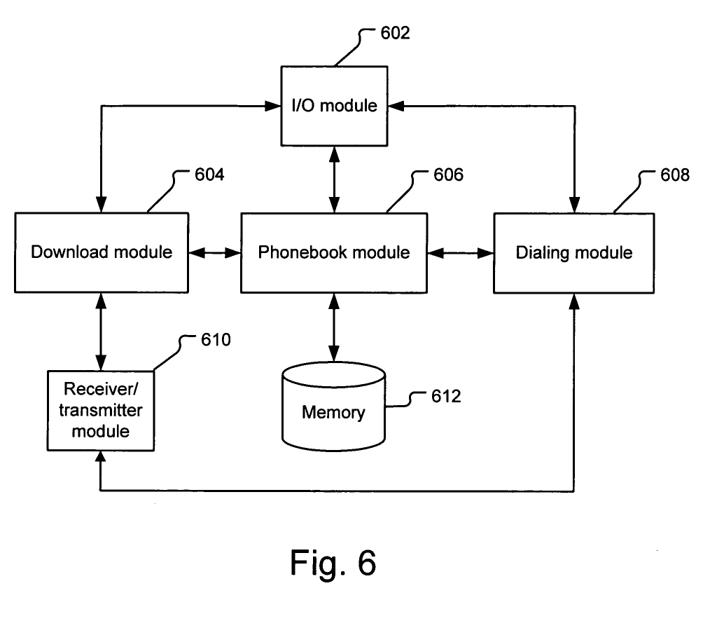

Receive operation 202 may receive data in accordance with any number of methods and/or protocols that are known in the art. A sampling of these methods and protocols are discussed below, in conjunction with FIG. 6.

In an embodiment, receive operation 202 receives contact information that is in response to a request from a cellular phone user to automatically store requested contact information in the memory of the cellular phone. An exemplary request may take the form of answering affirmatively to a prompt for automatic storage as illustrated in FIG. 1 by pressing a button, by speaking “Yes” into the phone, or other method.

Store operation 204 stores the data received by receive operation 202 into the memory of cellular phone. The memory of the cellular phone may be comprised of RAM (Random Access Memory), ROM (Read Only Memory), SRAM (Static Random Access Memory), DRAM (Dynamic Random Access Memory), SDRAM (Synchronous Dynamic Random Access Memory), flash memory, or other type or memory.

As discussed above in conjunction with FIG. 1, store operation 204 may store contact information in cellular phone memory associated with a phonebook, cellular phone memory associated with recently dialed calls, cellular phone memory associated with a redial command, or other region of cellular phone memory. In another embodiment, store operation 204 may store contact information in cellular phone memory associated with a combination of these cellular phone functions, or shared by a combination of these cellular phone functions.

In an embodiment, a directory assistance service is reached by a cellular phone user placing a phone call to a first phone number. The cellular phone user requests contact information including a second phone number that may be different from the first number. Receive operation 202 receives the contact information including a second phone number, and store operation 204 stores the contact information including a second phone number to the memory of the cellular phone. In a further embodiment, the user invokes the redial functionality of the phone through a button press or other input method. In response to the invocation of redial functionality, the cellular phone connects to the second phone number.

In an embodiment, contact information may be stored into cellular phone memory associated with a phonebook in accordance with one or more phonebook settings. Phonebook settings may be used to specify how information is to be stored (such as by last name first, or first name last, as the names may be alphabetized differently depending on how the two items are ordered during storage). In one embodiment, contact information may be stored in accordance with storage or other phonebook settings that are set by the user. In another embodiment, contact information may be stored in accordance with one or more default storage or other phonebook settings.

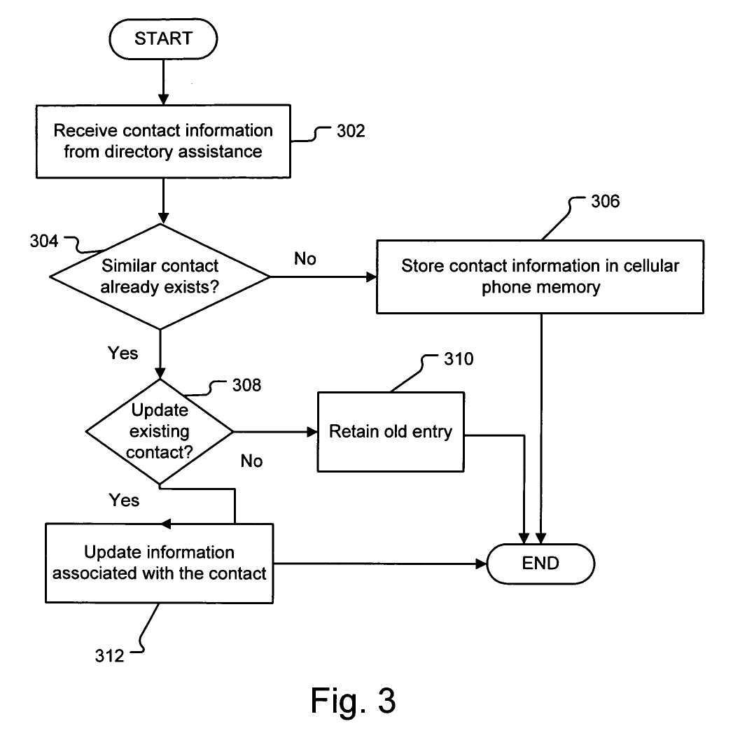

FIG. 3 illustrates operations in accordance with an embodiment wherein, prior to the storage of the new contact information corresponding to a contact, preexisting contact information for the contact is checked for. Receive operation 302 receives new contact information pertaining to a contact from a directory assistance service, similar to receive operation 202 (FIG. 2). Determine operation 304 then determines whether contact information corresponding to the contact already exists in the memory of the cellular phone. Determine operation 304 may automatically make this determination by comparing the existing contact information to the new contact information, more specifically comparing name, business name, date of birth, and/or other data. In an embodiment, contact information that looks like it may correspond to an existing contact is indicated as such to the user, who can then provide input to determine operation 304 as to whether the contact information relates to an existing contact.

If determine operation 304 determines that no contact information relating to the contact exists, then flow branches NO to store operation 306. Store operation 306 then stores the information to the memory of the cellular phone, similar to store operation 204. Alternatively, if determine operation 304 determines that contact information relating to the contact already exists, then flow branches YES to determine operation 308.

If determine operation 304 determined that contact information relating to the contact already exists, then determine operation 308 determines whether the existing contact information found by determine operation 304 should be updated. Determine operation 308 may make this determination based on user input (e.g., the user is presented with a question by the cellular phone as to whether the existing contact information should be updated), or based on a default setting (e.g., always update the phonebook, or always update the listing in question). If the existing contact information should be updated with the new contact information, flow branches YES to update operation 312. However, if the existing contact information should not be updated with the new contact information, flow branches NO to retain operation 310. In an embodiment, specific entries in the phonebook of the cellular phone may be write-protected by the user, such that updates will not occur at all, or alternatively, will not occur without the user's permission. In this way, an individual default setting may exist for each contact. In another embodiment, contact information relating to one or more contacts is periodically automatically updated by having the cellular phone periodically request an update for contact information relating to the contacts. The subsequent update occurs as described below.

If determine operation 308 determined that the existing contact information should not be updated, retain operation 310 retains the existing contact information. In an embodiment, the new contact information may be stored in the memory of the cellular phone as an additional entry. The additional entry may be linked to the existing information, or independent. In an alternate embodiment, the new contact information may simply be discarded.

If determine operation 308 determined that the existing contact information should be updated, update operation 312 updates the contact information. Update operation 312 may update the existing contact information by copying some or all of the new contact information into the cellular phone memory occupied by the existing contact information. In an alternate embodiment, the old contact information is erased, and the new contact information is stored in cellular phone memory. In still another embodiment, the cellular phone user may provide input to update operation 312 as to which elements of contact information should be replaced with the new information, and which should be retained.

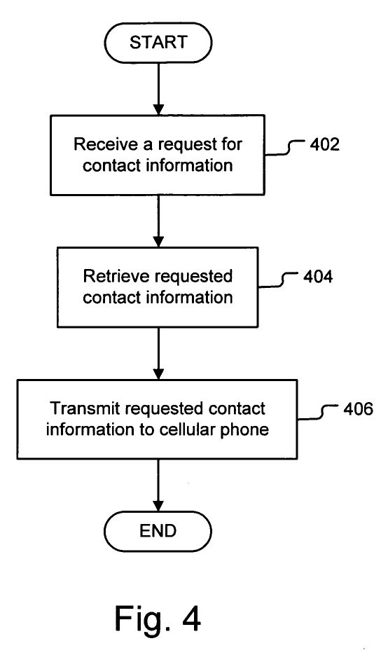

FIG. 4 illustrates operations in accordance with an embodiment wherein a request for contact information is processed by a directory assistance service. Receive operation 402 receives a request for contact information. Said request may be received via a phone call to a directory assistance phone system and speaking one or more words to a voice recognition system or to a live directory assistance operator. Alternatively, the request may be received via a contact information request entered into a cellular phone. The requested contact information is subsequently retrieved by retrieve operation 404.

Retrieve operation 404 can retrieve the requested contact information from a data source such as a database containing contact information using information lookup methods and data servers that are well known in the art. Transmit operation 406 then transmits the requested contact information to the cellular phone for storage in the memory of the cellular phone. In an embodiment, transmit operation 406 additionally transmits a command to store the contact information in the memory of the cellular phone. In an alternate embodiment, the cellular phone automatically stores received contact information into the memory of the cellular phone without relying on an explicit storage request.

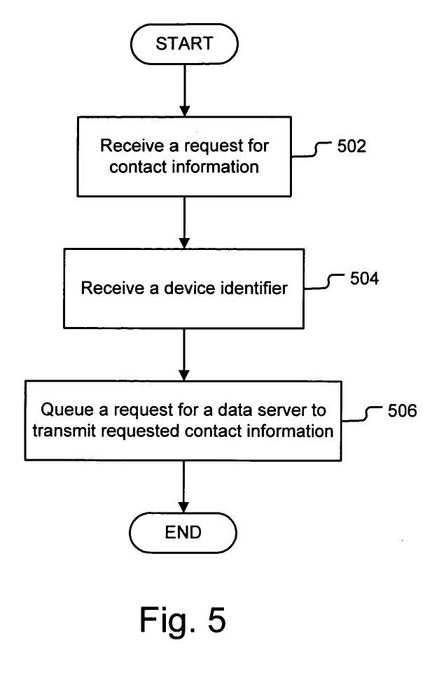

In an embodiment, the contact information is transmitted on a digital voice channel along with being verbally delivered to the cellular phone user. In another embodiment, the contact information is transmitted substantially simultaneously on two different channels on the wireless network such that the contact information is sent to the cellular phone at the same time a verbal interface is speaking the contact information. By transmitting on multiple channels, the cellular phone may receive and store the requested contact information while the phone number or other contact information is being verbally presented to the cellular phone user by the directory assistance operator or voice interface. The verbal and non-verbal contact information may be transmitted by the same directory assistance data resource, or by two separate resources such as an operator (verbal) and a data server (non-verbal) as discussed below in conjunction with FIG. 5. Embodiments of the claimed invention may communicate across one or more types of channels, including data channels, signaling channels, traffic channels, acknowledgement channels, control channels, pilot channels, synchronizing channels, or any combination thereof.

FIG. 5 illustrates operations in accordance with an alternative embodiment wherein a request for contact information is processed by a directory assistance service. Receive operation 502 receives a request for contact information. Said request may be received via a phone call to a directory assistance phone system using one or more spoken words to a voice recognition system or to a live directory assistance operator. Alternatively, the request may be received via a contact information request entered into a cellular phone. Receive operation 504 receives a device or customer identifier that indicates to which cellular phone(s) the requested contact information should be transmitted. In an embodiment, the identifier consists of a phone number. In another embodiment, the identifier consists of a customer number. A number may thus be transmitted to multiple cellular phones owned by a single customer. In still another embodiment, the identifier is an address on a wireless network, an encoded unique serial number for a cellular phone, or other means of addressing traffic to a cellular phone. The requested contact information is subsequently transmitted from a directory assistance data resource such as a data server containing contact information, or a database administration server capable of submitting queries to a data server containing contact information.

Queue operation 506 queues a request for a directory assistance data resource to transmit the requested contact information. When the queued request is eventually processed by the directory assistance data resource, a connection will be established to the cellular phone identified by the identifier received by receive operation 504, and the requested contact information will be transmitted for storage in the memory of the cellular phone.

In an embodiment, the identifier uniquely indicating the identity of a cellular phone customer is saved, and a fee subsequently charged for the transmission of the contact information for automatic storage in the cellular phone. In a further embodiment, the user is warned that the service will result in an additional fee when prompted to request that the information be automatically stored in the memory of the cellular phone.

In an embodiment in which a plurality of data formats may be required to support multiple cellular phone models, receive operation 504 receives version information from a cellular phone corresponding to the cellular phone software and/or the cellular phone hardware. This version information is used by receive operation 504 to select a data format which is usable by the cellular phone, said data format being used when transmitting the requested contact information for storage in the memory of the cellular phone. In an alternate embodiment, software handshaking and/or hardware handshaking is required to determine a usable data format for the cellular phone.

FIG. 6 is a block diagram illustrating the modules that comprise one embodiment of the present invention. An Input/Output (I/O) module 602 allows a cellular phone user to access the cellular phone's functionality, and interact with some cellular phone modules. I/O module 602 accepts user input in the form of button presses and verbal commands. I/O module 602 also displays information on the cellular phone's display device (not pictured). More particularly, I/O module 602 allows a user to interact with download module 604, including sending download control commands (such as a command to cancel the download, or a command to suspend the download), and receiving information about how a download is progressing, whether a download control command was executed successfully, and whether the download was successful. I/O module 602 also allows a user to interact with phonebook module 606. Requests to create, delete, modify, or view contact information may be sent to phonebook module 606, and the results of these requests may be sent back to I/O module 602 so that they may be reported to the user via the display device (not pictured). I/O module 602 also allows a user to interact with dialing module 608. A request to dial a number may be sent to dialing module 608 by I/O module 602. Similarly, a request to cancel a call in the process of being dialed by dialing module 608 may be sent by I/O module 602. Information regarding the results of these requests may be received by I/O module 602 from dialing module 608, as may information regarding which number is currently being dialed.

Download module 604 downloads contact information from a directory assistance service. The contact information is received by receiver/transmitter module 610, and is sent by download module 604 to phonebook module 606 for storage. In an embodiment, download module 604 sends a request to store contact information to phonebook module 606 along with the contact information to be stored by phonebook module 606. In another embodiment, no such request to store contact information is required. Download module 604 receives download commands from I/O module 602, and sends information about how a download is progressing, or information about the result of a download control command to I/O module 602. Similarly, download module 604 may send information about whether a download was successful to I/O module 602.

Phonebook module 606 allows storing, retrieving, and managing contact information in cellular phone memory 612. In an embodiment, phonebook module 606 also manages updating existing contact information relating to a contact. To this end, phonebook module 606 may interact with I/O module 602 to allow a user to control how new contact information is applied with regard to existing contact information.

Phonebook module 606 may receive requests from I/O module 602 to create, delete, modify, and view contact information. The results of such a request, including the requested contact information, may similarly be sent back to I/O module 602 by phonebook module 606. Requests to store downloaded contact information may be received by phonebook module 606 from download module 604. Phonebook module 606 may send contact information to dialing module 608 for dialing. The contact information sent to dialing module 608 may include not only a phone number, but also a contact name and/or digital image to be displayed by the cellular phone during dialing. In another embodiment, the contact information sent to dialing module 608 includes audio data such as a spoken name, a business-related soundbyte, an advertisement, or a message. Phonebook module may issue read commands and write commands to memory 612 in the course of retrieving, and storing contact information, respectively. Memory 612 may be comprised of RAM (Random Access Memory), ROM (Read Only Memory), SRAM (Static Random Access Memory), DRAM (Dynamic Random Access Memory), SDRAM (Synchronous Dynamic Random Access Memory), flash memory, or other type or memory.

Dialing module 608 initiates cellular phone calls. Dialing module 608 may receive requests to dial a phone number, or a request to cancel dialing, from I/O module 602. Information regarding the results of these requests may be sent to I/O module 602 by dialing module 608. Similarly, information regarding the number and/or contact that is presently being dialed may be sent by dialing module 608 to I/O module 602 for display. Information on which contact to dial may be received by dialing module 608 from phonebook module 606. Dialing module 608 then uses receiver/transmitter module 610 to initiate calls Receiver/transmitter module 610 provides wireless communication to the telephone network, as well to a directory assistance service. Receiver/transmitter module 610 may send requests for contact information to a directory assistance service over a wireless network. Receiver/transmitter module 610 may also receive contact information from a directory assistance service. This contact information is sent to download module 610. Receiver/transmitter module 610 may use a variety of wireless protocols, some of which are described below.

Embodiments of the present invention may be implemented in conjunction with any combination of physical, data link, network, transport, session, presentation, and application layer protocols without departing from scope of the claimed invention. More specifically, embodiments of the present invention may communicate using any application layer transport protocol, including, but not limited to, WAE (Wireless Applications Environment), FTP (File Transfer Protocol), SMTP (Simple Mail Transfer Protocol), HTTP (Hyper Text Transfer Protocol), and Telnet. Further, embodiments of the claimed invention may communicate using any presentation layer transport protocol, including, but not limited to, XDR (External Data Representation) and LPP (Lightweight Presentation Protocol). Further, embodiments of the claimed invention may communicate using any session layer transport protocol, including, but not limited to, WTLS (Wireless Transport Layer Security), WTP (Wireless Transport Protocol), DNS (Domain Name System), and LDAP (Lightweight Directory Access Protocol). Further, embodiments of the claimed invention may communicate using any transport layer protocol, including, but not limited to, WDP (Wireless Datagram Protocol), TCP (Transport Control Protocol), and UDP (User Datagram Protocol). Further, embodiments of the claimed invention may communicate using any network layer protocol, including, but not limited to, IP (Internet Protocol), IPX (Internetwork Packet Exchange), CLNP (Connectionless Network Protocol), and IDP (Internetwork Datagram Protocol). Further, embodiments of the claimed invention may communicate using any datalink layer protocol, including, but not limited to, 802.2, HDLC (High Level Data Link Control) and PPP (Point to Point Protocol). Further, embodiments of the claimed invention may communicate using any physical layer protocol, including, but not limited to, CDMA (Code Division Multiple Access), TDMA (Time Division Multiple Access), SDMA (Spatial Division Multiple Access), FDMA (Frequency Division Multiple Access), Ethernet, Token Ring, and FDDI (Fiber Distributed Data Interface). Embodiments of the claimed invention may leverage service applications such as SMS (Short Messaging Service), which operates between protocol layers. Embodiments of the claimed invention are also envisioned in the context of other mobile communication devices, including, but not limited to, vehicle phones and satellite phones.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A method for automatic storage of contact information received from a directory assistance service into a memory of a cellular phone, said method comprising:
receiving, on the cellular phone, the contact information from the directory assistance service; and
automatically storing the contact information into the memory of the cellular phone.

2. A method as defined in claim 1, wherein the memory is associated with a phonebook.

3. A method as defined in claim 1, wherein the memory is associated with one or more recently dialed calls.

4. A method as defined in claim 3, wherein the memory is referenced by a redial function in the cellular phone.

5. A method as defined in claim 1, wherein the contact information include a data element, or a combination of data elements, selected from the group consisting of a contact name, a photographic image associated with a contact, a phone number, a business name, a digital image containing a business logo, a digital image containing an advertisement, a mailing address, an email address, a uniform resource identifier, an audio recording of a name, an audio recording of a message, an audio recording of a business-related soundbyte, and an audio recording of an advertisement.

6. A method as defined in claim 1, further comprising temporarily storing the contact information in the memory of the cellular phone, such that the contact information is capable of being stored more permanently in the memory of the cellular phone responsive to a request by a cellular phone user.

7. A method as defined in claim 1, wherein the contact information is received for automatic storage substantially simultaneously with the contact information being received via a verbal directory assistance interface.

8. A method as defined in claim 1, further comprising determining whether a contact associated with the received contact information already exists in the memory of the cellular phone.

9. A method as defined in claim 8, further comprising updating the contact with the received contact information.

10. A method as defined in claim 9, wherein the contact may be write-protected against updates by a user.

11. A method as defined in claim 9, wherein one or more contacts may be periodically automatically updated without recurring requests from a user.

12. A method for transmission of requested contact information to a cellular phone for automatic storage in a memory of the cellular phone, said method comprising:
receiving a request for contact information;
retrieving the requested contact information; and
transmitting the requested contact information to a cellular phone for automatic storage in the memory of the cellular phone.

13. A method as defined in claim 12, further comprising transmitting a command to store the requested contact information in the memory of the cellular phone.

14. A method as defined in claim 12, wherein the requested contact information is sent by a directory assistance service responsive to a voice input.

15. A method as defined in claim 12, wherein the contact information is sent by a directory assistance service responsive to one or more inputs generated by button presses on the cellular phone.

16. A method as defined in claim 12, wherein the requested contact information is transmitted by a directory assistance service substantially simultaneously with the contact information being verbally delivered to a cellular phone user by a directory assistance operator or directory assistance voice interface.

17. A method as defined in claim 12, further comprising receiving an identifier, said identifier being used to subsequently initiate a connection with the cellular phone for transmitting the requested contact information.

18. A method as defined in claim 12, further comprising recording a fee for transmitting the contact information, said fee being associated with an account associated with the cellular phone.

19. A method as defined in claim 12, further comprising receiving a selection of an existing contact in the memory of the cellular phone for which updated contact information is requested.

20. A system for automatic storage of contact information received from a directory assistance service into a cellular phone memory, said system comprising:
an I/O module for receiving input from a user, and displaying information to a user;
a receiver/transmitter module for transmitting requests for contact information to a directory assistance service, and receiving contact information from a directory assistance service;
a download module for managing downloads of contact information received through the receiver/transmitter module;
a phonebook module for storing and retrieving contact information downloaded by the download module, and contact information entered by a cellular phone user;
a dialing module for dialing a phone number; and
a memory for storage of contact information associated with the phonebook module.
